(19) United States
(12) Patent Application Publication
(10) Pub. No.: US 2001/0034972 A1
(43) Pub. Date: Nov. 1, 2001

(54) Method for making and delivering radial floral arrangement apparatus

(76) Inventor: David Immel Masters, Incline Village, NV (US)

Correspondence Address: Charles Hartman, P. O. Box 926, Reno, NV, 89505, US

(21) Appl. No.: 09/826,983

(22) Filed: Apr. 4, 2001

Related U.S. Application Data
(60) Provisional application No. 60/128,919, filed on Apr. 12, 1999.
(60) Provisional application No. 60/141,924, filed on Jun. 30, 1999.

(51) Int. Cl. A01G 1/00

(52) U.S. Cl. 47/58.1

(57) ABSTRACT

A method for selling, arranging, and transporting decorative flowers without a vase or floral foam. Flower stems are placed in a plurality of receiving channels in an apparatus that receives flower stems. Once the arrangement is made, the flowers and supporting member can be placed in a container for delivery to the recipient of the flower arrangement.

### BACKGROUND OF THE INVENTION

1. Field of the Invention

This invention relates to apparatus for the floral industry; more particularly, this invention relates to apparatus and aids for arranging flowers either in a warehouse or factory setting or at the point of sale, to provide easily transportable arrangements that need not be in a vase; most particularly this invention relates to apparatus for steadying hand held floral arraignments as they are made.

2. State of the Art

Currently, one favored method of arranging flowers by a florist is inserting cut flowers into floral foam, a material that is porous enough to allow water to soak the foam, and strong enough to support the stems of flowers inserted there into. The floral foam is placed into a vase or similar container, and the flower stems are placed in foam. Other articles, such as babies' breath, fern and the like may also be placed in the floral foam, or, in the case of a bridal bouquet, a foam-filled handle may be used to allow the insertion of the arrangement. Among the problems created by the use of foam are a) the foam must be wetted before the flowers can be inserted, and b) the foam must be placed in a vase or the like before the flowers or the like are placed in the arrangement.

Other methods are, of course, used to create arrangements by the florist. Sometimes enough flower stems are used to allow an experienced and talented florist to create a nest or weave of stems to support the arraignment without recourse to an extra supporting means. Or the florist may use floral tape to wrap the arrangement. This tape is used on the top of the vase to create a grid into which the floral stems may be placed. Similarly, there are available to the florist, pre-made grids of plastic or similar material that snap onto the top of vases. The problem with these methods is they all require the use of a vase.

Another problem with all the above identified methods is the requirement that water be used in conjunction with the vase. Water creates problems in the many instances where water is undesirable. Similarly, none of the above described methods, with the exception of floral tape for when used to make small bouquets, allow the arranger to be able to hold the growing arrangement his or her hand as he or she creates the arrangement. This can cause arrangements made with floral foam, tape, and the like, to be asymmetric because the arranger may not be able to balance the flowers in the arrangement at the time the arrangement is created. Moreover, in the case of floral foam, the structure of the floral foam may fail after some amount of time to continue to support some of the flowers in the arrangement, causing the arrangement to sag with time.

In the flower-by-wire industry, the arrangements are selected by the customer at a remote location from a book, paid for at the remote location, and then florist who sold the arrangement calls a remote florist to make the arrangement and deliver it to a recipient local to the remote florist. The customer must select the arrangement from a book, and have some degree of confidence that the remote florist will make what is depicted in the book. Any aid or guide to help the remote florist more competently and consistently arrange flowers exactly as depicted in the book would be of great benefit to the industry and prevent misunderstandings about the nature of the flowers and arrangements ordered.

Although it will be appreciated that the talent and skill of the remote florist are still essential to make a suitable arrangement, it would be greatly advantageous to have a flower arranging device or aid to allow the remote florist to easily place the flowers in an arrangement precisely, symmetrically and permanently; and especially, it would be advantageous to have a system where the remote florist can hold the arrangement in his hands as he is making it, to allow more artistic freedom in the creation of the arrangements. It would be especially advantageous for the flower-by-wire industry, and promote consistency and reproducibility of flower arrangements to be made by all the florists connected by the wire service. This would, in turn, help promote customer satisfaction with the industry.

### SUMMARY OF THE INVENTION

This invention provides a method for selling, arranging, and transporting decorative flowers without a vase or floral foam. Flower stems are placed in a plurality of receiving channels in an apparatus that receives flower stems. Once the arrangement is made, the flowers and supporting member can be placed in a container for delivery to the recipient of the flower arrangement.

This system provides a unique approach to arranging flowers since it aids, not only in supporting the flowers while creating a bouquet, but allowing the floral arrangement to exist outside a vase during creation and as fully designed. This allows the creation of single piece bouquets, including the apparatus used to make the bouquet, and a wire, a tape, or similar binding device to bind the stems of the flowers, that are easily transportable to an intended destination vase or container. Similarly, the prepared bouquet can be placed in a container specifically intended for the bouquet in the floral shop.

This system provides a self-supporting method that allows the entire finished product to be constructed as a single transportable piece that holds together and is portable before being placed in a container. This feature allows the creation of single-piece bouquets that can be transported before being placed in a container or immediately dropped into a container for which it was created. The method of creation of self-supporting bouquets of the present invention allows the creation of a self-supporting bouquet, for vase or other container, while held in the hands of the designer while it is being created without the necessity of using the vase or other container during the construction of the bouquet.

This invention also allows florists and others to make very repeatable arrangements and allows easy transportation of the arrangements to the customer. The nature of this invention is easy enough to allow unskilled customers to arrange their own bouquets at the point of purchase that will look like they have been arranged by a professional florist.

An aspect of this invention is a method for arranging flowers comprising placing at least one first flower stem in at least one flower stem channel of a flower holding member having a plurality of flower stem channels; placing at least one second flower stem in a second flower stem channel of the flower holding member having a plurality of flower stem channels; and placing the arranged flowers in a display device.

An aspect of this invention is a method for transporting flower arrangements comprising placing at least one first flower stem in at least one flower stem channel of a flower holding member having a plurality of flower stem channels; placing at least one second flower stem in a second flower stem channel of the flower holding member having a plurality of flower stem channels; placing the arranged flowers in a display device; and transporting the display device with the flowers in the arrangement to a point of display for the flowers.

An aspect of this invention is a method for transporting flower arrangements comprising: placing at least one first flower stem in at least one flower stem channel of a flower holding member having a plurality of flower stem channels; placing at least one second flower stem in a second flower stem channel of the flower holding member having a plurality of flower stem channels; placing the arranged flowers in a display device; placing the display device inside a protective transport container; and transporting the protective transport container containing the display device with the flowers in the arrangement to a point of display for the flowers.

### BRIEF DESCRIPTION OF THE DRAWINGS

FIG. 1 shows a perspective view of an unassembled center member receiving a flower stem.

FIG. 2 shows a perspective view of the assembled center member of FIG. 1 with the received flower stem.

FIG. 3 shows a perspective view of the partially assembled floral bouquet showing the addition of an outer member to secure the flower stems into place.

FIG. 4 shows a perspective view of the partially assembled floral bouquet showing the addition of yet the next layer of flowers to the arrangement.

FIG. 5 shows a perspective view of the partially assembled flower arrangement of FIG. 4 showing the addition of yet another layer.

FIG. 6 shows a perspective view of the final arrangement, placed in a vase ready for display.

FIG. 7 shows a perspective view of an alternative embodiment showing a frame apparatus for arranging flowers without a vase.

FIG. 8 shows a perspective view of the embodiment shown in FIG. 7 showing the embodiment in an exploded view with a vase and an insert in the vase showing one exemplary flower arranged using that system.

FIG. 9 shows a perspective view of the embodiment shown in FIG. 8 completely inserted into the vase.

FIG. 10 shows a perspective view of an embodiment with the rings in exploded arrangement above a vase to show their relative positions.

FIG. 11 shows a perspective view of the embodiment shown in FIG. 10 with the rings inserted into the vase.

FIG. 12 shows a perspective view of yet another similar embodiment with the rings shown in exploded view to show their relative relations to each other.

FIG. 13 shows a perspective view of an alternate embodiment to arrange flowers, showing the embodiment partially rolled, and the relationship of the flowers arranged in the embodiment.

FIG. 14 shows a perspective view of the embodiment of FIG. 13 showing the embodiment completely rolled with a bouquet of flowers arranged using the embodiment.

FIG. 15 shows an alternate embodiment to arrange flowers by hand using a hand-held device to arrange the flowers.

FIG. 16 shows yet another embodiment to arrange flowers while holding the arraignment and the flowers in one hand to allow for easy and facile arrangement of the bouquet being made.

FIG. 17 shows an embodiment of displaying flowers and accessories to customers at a point of sale display.

FIG. 18 shows how flowers might be transported home once an arrangement has been made at the point of sale using the device of FIG. 17.

### DETAILED DESCRIPTION OF THE PREFERRED EMBODIMENT

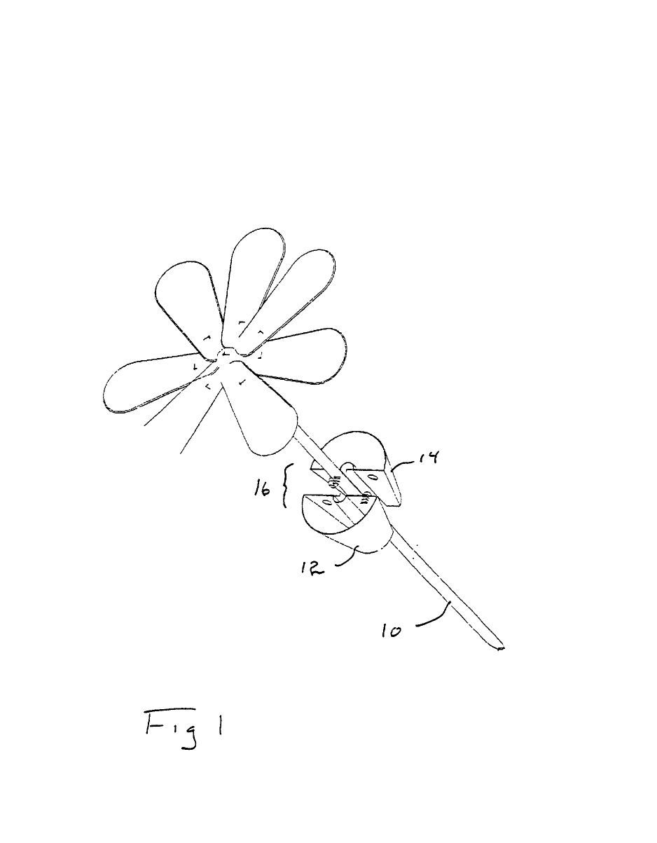

Referring now to FIG. 1, a flower stem 10 is encircled by a first side member 12 and a second side member 14 of a center member. The first and the second side members will be joined to form the center member 16.

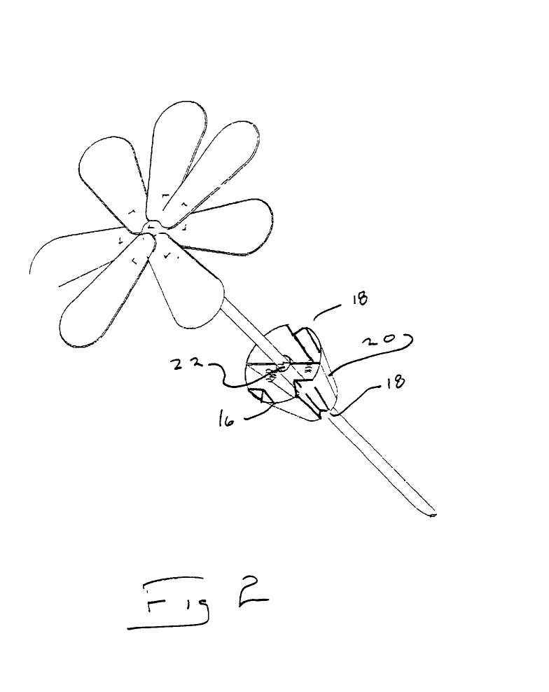

Referring to FIG. 2, the basic apparatus for arranging flowers includes a center member 16, shown here assembled, having a plurality of flower channels 18 on the outer side surface 20, and a newly created central orifice 22 in its center for the placement of a flower stem. There are flower channels disposed around the circumference of the outer side surface. Preferably there are between two and eight flower channels, more preferably between two and four, and most preferably three, as shown in this FIG.

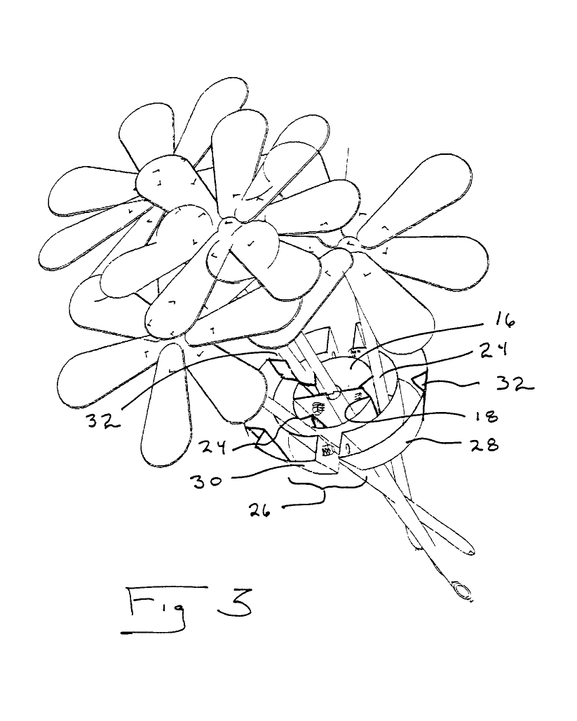

Referring to FIG. 3, flower stems 24 are placed in the flower channels 18 of the central member 16. Three flower channels 18 are shown here. An outer member 26, having a first side member 28 and a second side member 30, having a second plurality of flower channels 32 on the out side surface is placed around the placed flowers, thereby securing them into position. The outer member nests with the center member.

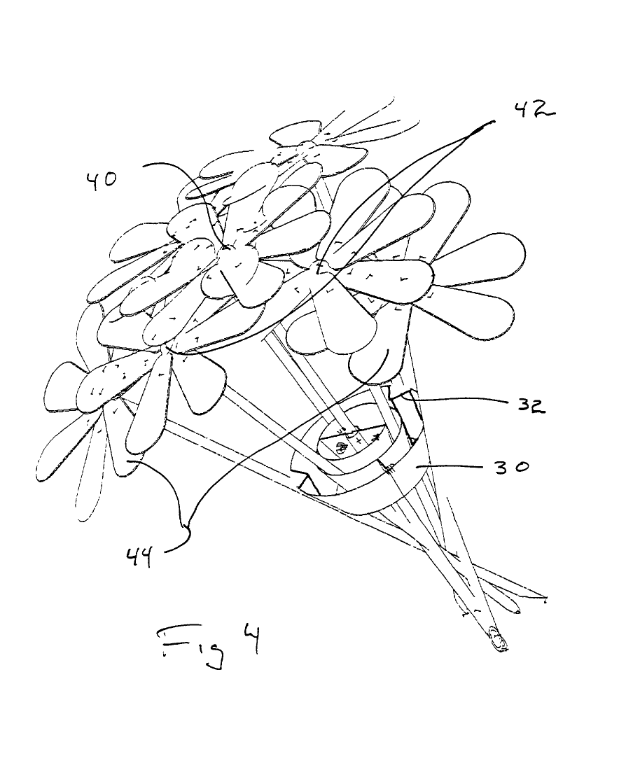

Referring to FIG. 4, a second layer of flower stems is arranged around the outside of the assembled outer member 30, in the flower receiving channels 32. At this point in the arranging process, there is a central flower 40, a first layer of flowers 42 and a second layer of flowers 44. It should be realized that although flowers are being shown in the Figs., other foliage and the like can be added to the arrangement to give a polished and professional look to the final arrangement. It should also be realized that the floral arrangement can be held in the arranger's hand or placed in a vase or similar device to help steady the arrangement as it grows.

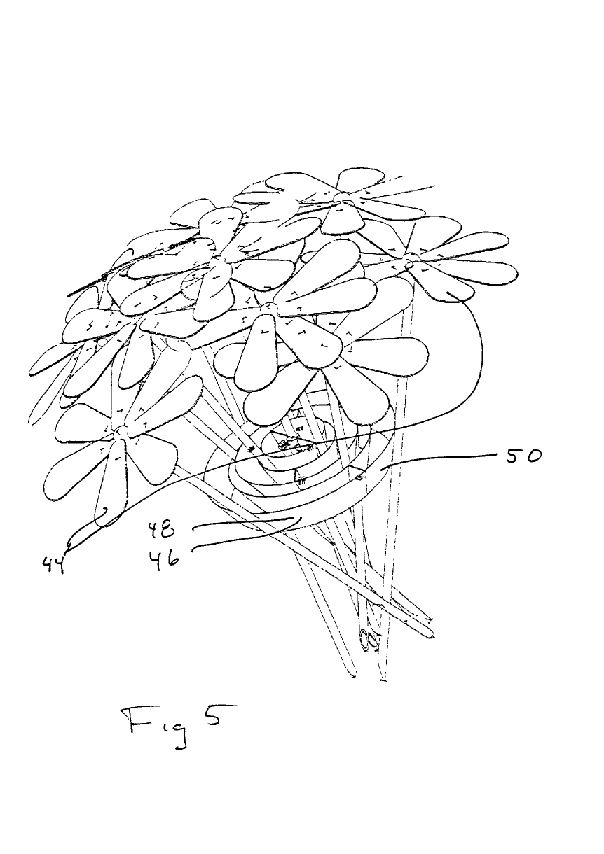

Referring to FIG. 5, the second layer of flowers 44 is secured by a second outer member 46. In a preferred embodiment, the second outer layer includes a first side member 48 and a second side member 50 (shown assembled in the Fig). The first side member and the second side member are placed together, and joined. In a preferred embodiment, the side members are made of hard plastic and the first and the second side members are snap fit together. Fitting the two halves together as the flowers are arranged allows the arranger to account for any unfairness in the natural sizes of the stems of the flowers, and allow for a better and more reproducible fit of the arrangement. A third layer of flowers is placed around the second outer member.

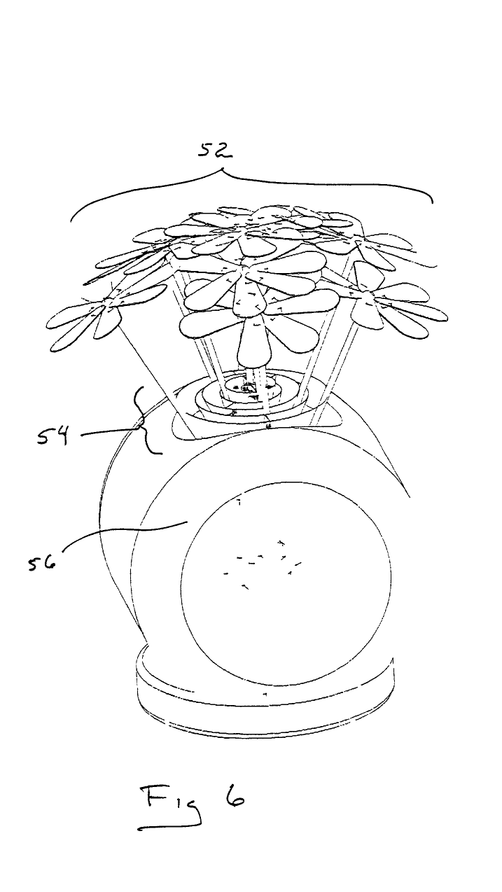

Finally, referring to FIG. 6, the arrangement of flowers 52 and the nested flower securing devices 54 are placed in a display device 56. In the device, shown in this FIG. a central member is nested with two outer members. However, usually, more or fewer nested outer layers can be added depending on the size and the nature of the arrangement desired. The display device can be, for example, a conventional vase, including ceramic, glass, metal, and other materials that can hold flowers and are sufficiently waterproof. In one embodiment, the display device is a hand-held device for bridal bouquets and the like. The invention allows a hand-held bouquet, a “loose-tied” bridal bouquet, to be created that allows the flowers of the bouquet to be held apart and not crushed together. Another great advantage of this invention is that the arrangement can be used in a vase provided at the destination. In other words, the arrangement can be made, and transported to a destination, usually in a box, and then placed in a display device.

The central member and the surrounding members can be made of any reasonable material. Preferred materials include porous materials, for example, floral foam, Styrofoam, foam polyurethane, and the like. Porous materials may be used when the flower support of the invention is to be the primary support and water supply for the entire bouquet. Conversely, non-porous materials may be used, for example, polyethylene, polypropylene, various high impact plastics and the like. Non-porous materials are used in the situation where the supporting member is used to place the bouquet in a vase or other water supplying source. Other materials and the like for example, metals, such as aluminum may also be beneficially used.

The central member and the surrounding members can be solid, that is, made of a block of material, or hollow, that is a shell having an outer side, an inner side, and a bottom or an outer side, an inner side and no bottom. The choice is dictated by weight considerations and secondary considerations such as the need for a holder for floral foam for foliage and the like. In general the choice of solid versus hollow will not affect the choice of material chosen for the members. The hollow portion of the members can be used for placing other flowers or foliage. Being hollow, it can be used to place floral foam and the like for supporting other flowers and foliage.

To some extent the material used depends on whether the flower supports are to be reused or not. The more reusable the flower support, the more robust the material should be.

It is preferred that the material be resilient against deformation caused by flower stems and the like. That is, it is preferred that the material chosen for construction of the apparatus of this invention hold the stems of the flowers in the arrangement firmly, and not allow the flower stems to work their way loose. This is especially important if the arrangement is held or otherwise not held in a secure display device. In one preferable mode of operation, the flower stems are tied together using wire, string, rubber bands, Sip Ties TM and the like. This forces the flowers against the apparatus and prevents them from inadvertently falling out; therefore, tying the ends firms up the arrangement and prevents it from falling apart.

This invention allows the arrangement of various types of flowers, including roses, carnations, mums, and other long stem flowers. Other foliage may be arranged using the supporting members of this invention as well, such foliage including ferns, broad leaf foliage, babies' breath and the like.

The display device chosen for the arrangement once made might be a vase, or a handle, in the case of a bouquet to be held by a bride or the like. The requirements for the display device are essentially that it is waterproof.

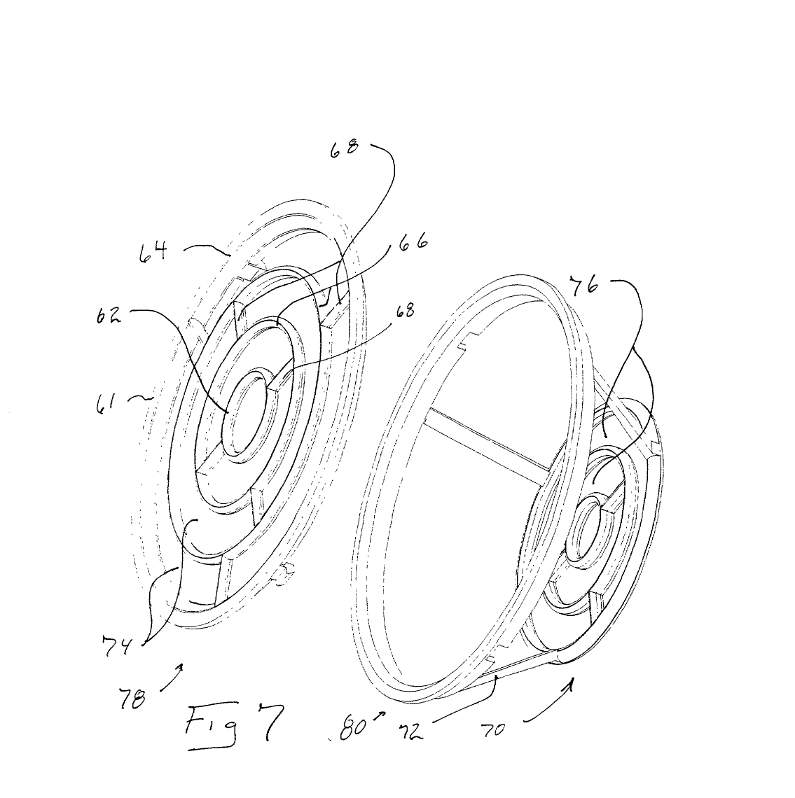

Referring to FIG. 7, in an alternative embodiment 60 comprises an apparatus for arranging flowers. A top member 61 includes a center ring member 62 and at least one outer member 64 are connected to the center ring member by radially arrayed connecting members 68. In FIG. 7,1 two additional ring members 66 are shown between the center ring member and the out ring member. A lower series of nested rings 70 is connected to the top series of nested rings by vertical supporting member 72. In this embodiment, the gaps 74 and 76 formed by the center ring member, the outer member and the connecting members define a plurality of flower channels. This embodiment is used by placing the apparatus in a vase or, more preferably, holding it in the hand and arranging flowers using the plurality of flower channels defined in the apparatus. The apparatus includes those flower holders including a first level of flower receiving channels and a second level of flower receiving channels, the first level and the second level joined by at least three joining members. It will be appreciated that the top member 78 will be snap fitted to the bottom member 80 before the apparatus is used.

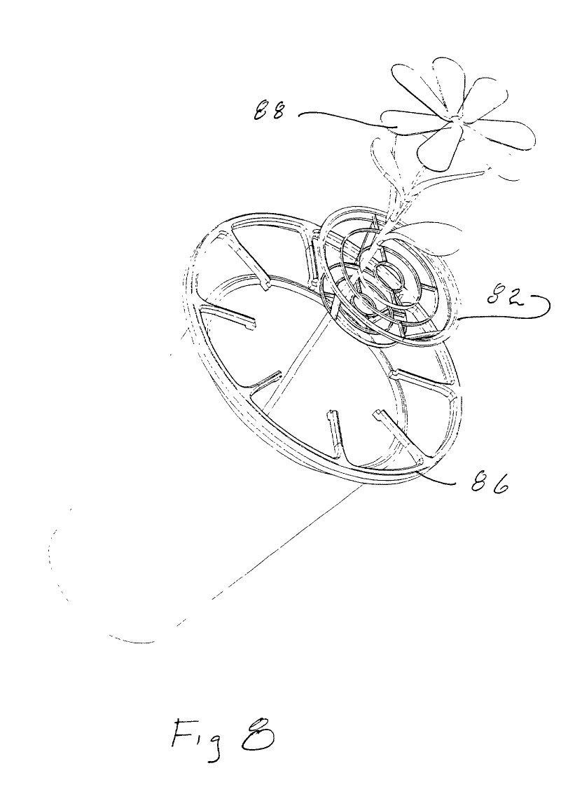

Referring to FIG. 8 the apparatus 82 for displaying flowers is assembled and placed in a vase 84. While the apparatus may be slightly larger than the opening of the vase, the edge of the vase is not the preferred support for the device. A support ring 86 will normally be used to support the apparatus and the growing arrangement of flowers 88 in the vase mouth. A flower, representing the growing arrangement, has been placed in the center part of the apparatus. Similarly, to make an acceptable arrangement, other flowers would be placed in the center part, and then more flowers would be added by placing them in the outer part of the apparatus. It is important to realize that the flower arrangement may be held in the florists' hand rather than being supported by the top of the vase.

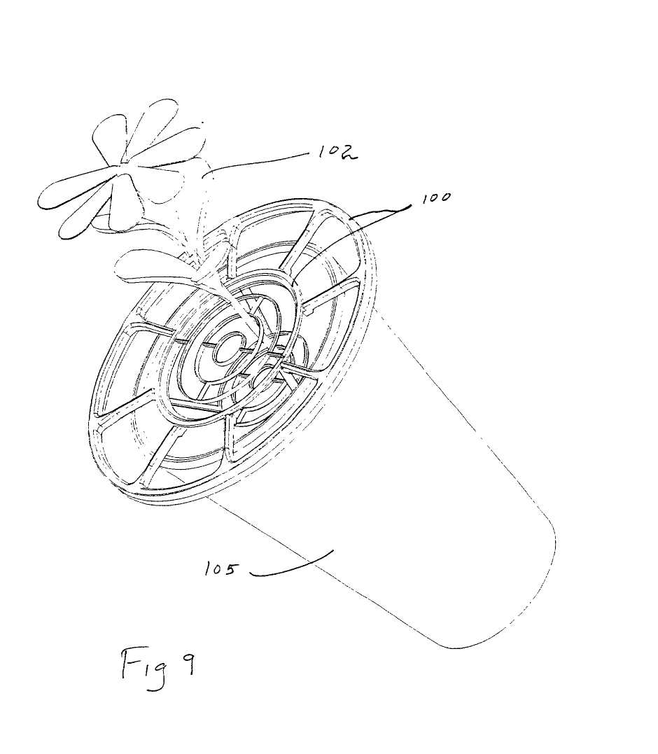

Referring to FIG. 9, the apparatus 100 and the flowers 102 can be placed in a vase. This is, of course true whether for the arranging of the flowers or to place the arrangement into the vase 105.

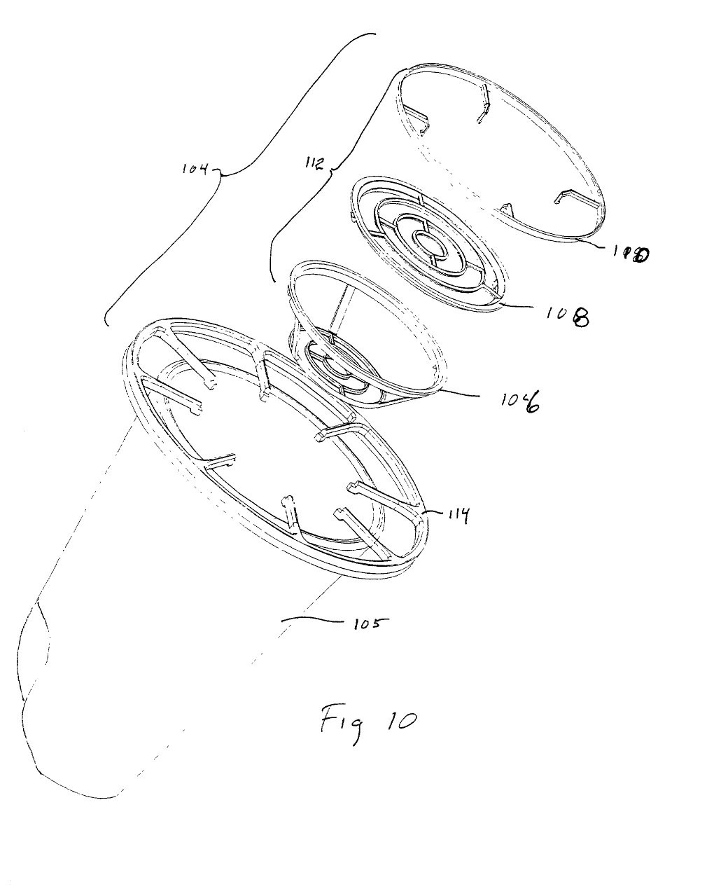

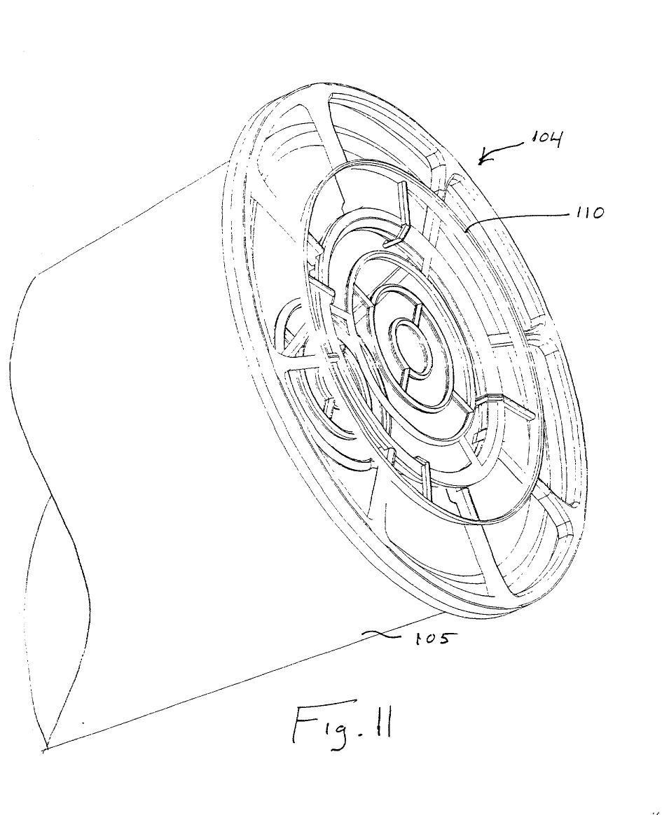

Referring now to FIG. 10, the apparatus 104 placed into the vase 105 has a lower a part 106, and an upper part 108, and an upper extension 110. The upper extension is used to provide extra support for the assembled inner 112 and outer parts 114. Referring to FIG. 11 ,the upper extension of the apparatus 104 can provide extra spaces to place flowers.

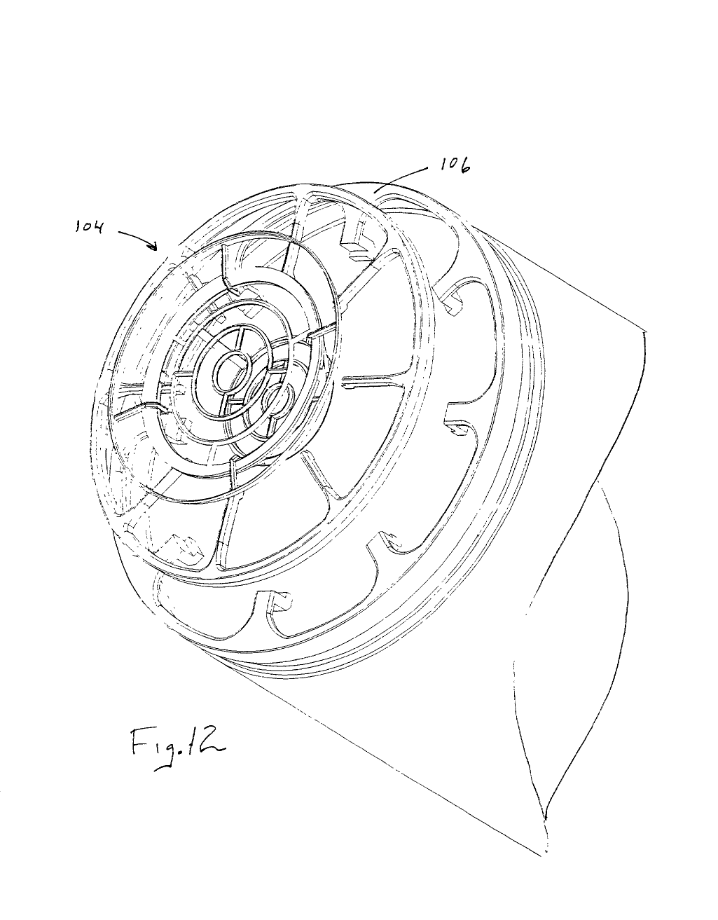

Referring to FIG. 12, the apparatus 104 can be used to create very large arrangements by using an extra outer ring 106.

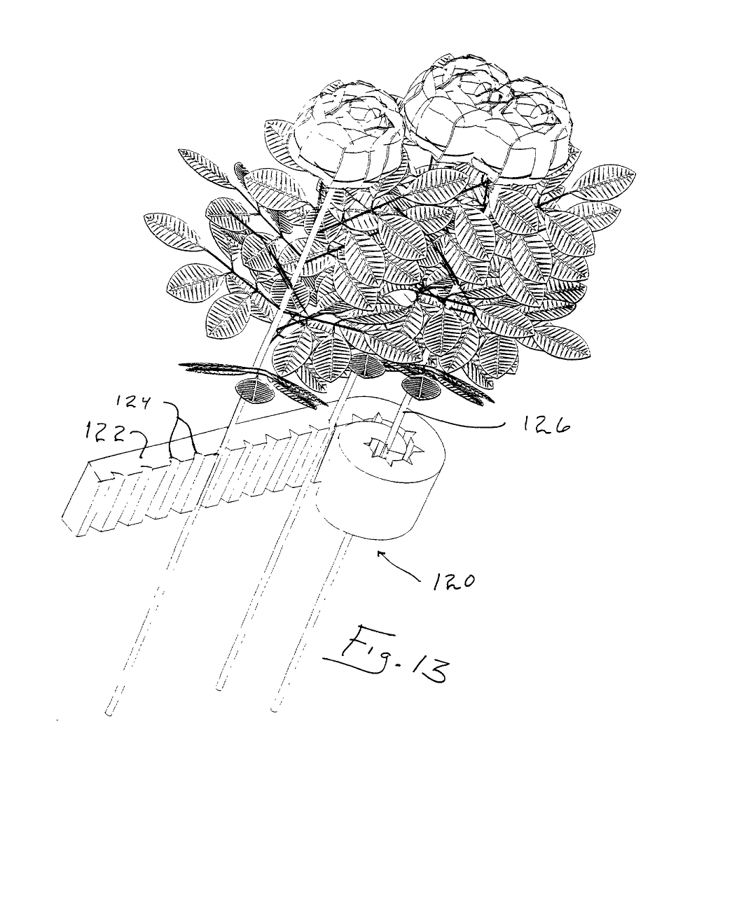

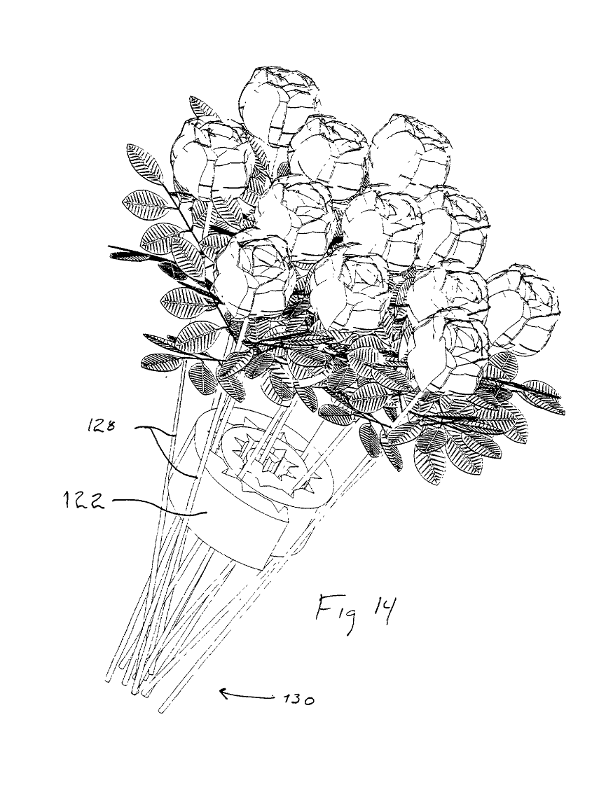

In yet another embodiment, shown in FIG. 13, in a slightly different flower arranging apparatus 120 that can be used with the present method can be, for example, a length of flexible material, 122, for example plastic or paper, of substantial thickness, perhaps between about one and five centimeters, having a plurality of notches 124 or the like embossed on its surface. The notches are about half the depth of the flexible material. Flowers 126 are placed in the notches as it is rolled up. As shown in FIG. 14, the length of flexible material 122 can then be rolled up, new flower stems 128 placed in the notches as they are rolled up, creating an attractive arrangement. In this manner a quick arrangement can be made and is ready for transportation as soon as the loose ends 130 of the flower stems are bound together to stabilize when it is finished.

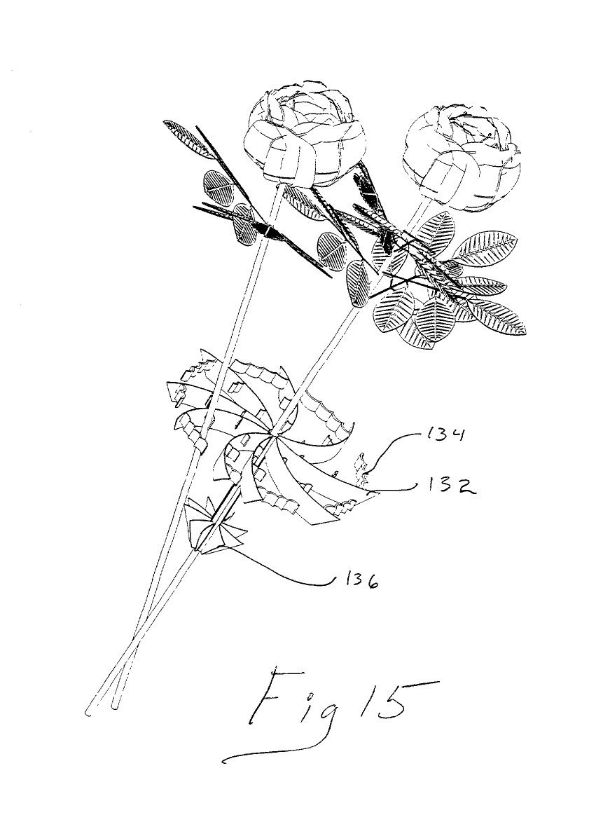

Similarly, as shown in FIG. 15, a hand held spiral arranging apparatus 132 can be used as well. Using this apparatus, the flowers are held in place by the flower holding members 134, and 136. When the arrangement is finished, the loose ends are bound and the arrangement is placed in a vase or transported.

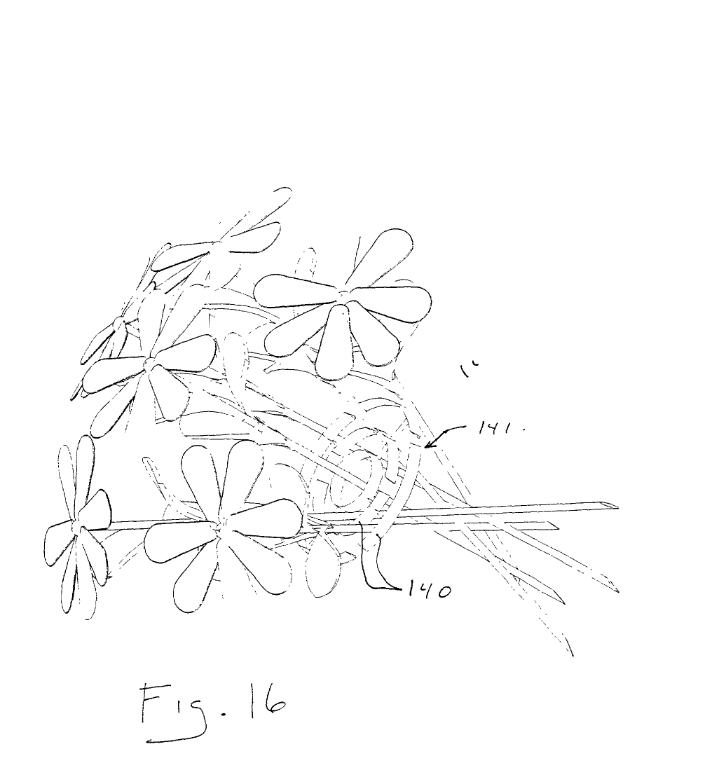

Similarly, as shown in FIG. 16, in yet another embodiment 141, a nested series of arcuate rings 140 made of plastic or similar material, can be used to hold flowers in an arrangement in the hands of the arranger while the arrangement is being prepared by the arranger.

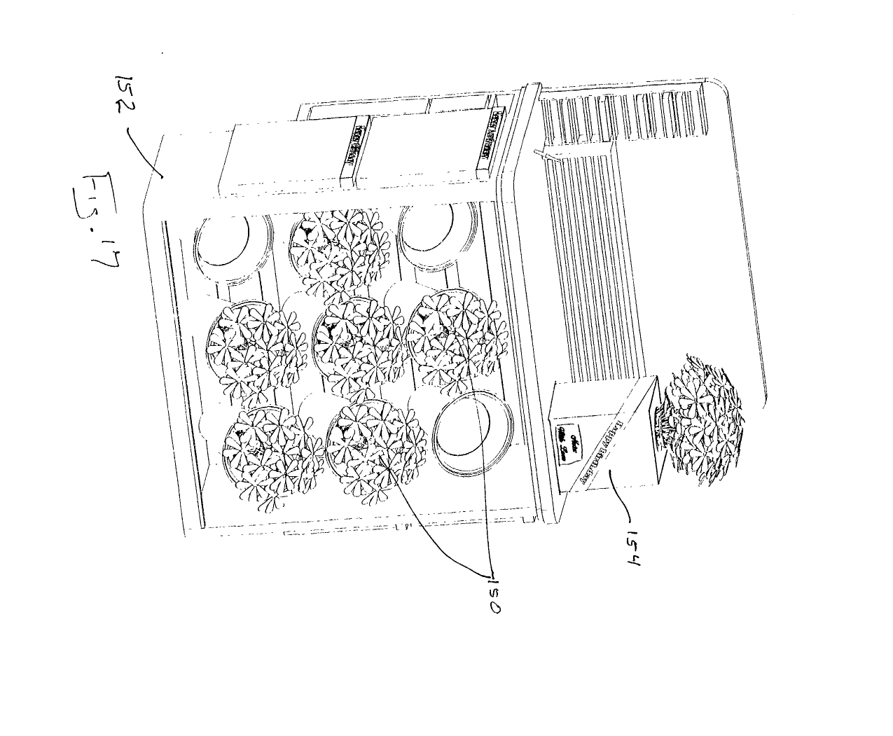

Referring now to FIG. 17, in one preferred embodiment of selling arrangements 150 made remotely at a warehouse or similar location and transported to, for example a store or other retail establishment, and placed in a convenient location for sale of the completed arrangements. Such locations include supermarkets or large retail stores. There, a stand 152, the preferred stand is shown in the FIG. 17, but similar display areas can be advantageously used as well, allows the showing of the prearranged flowers. A sales person may be present to help the customer to customize his or her arrangements; however, this is not necessary. The embodiments for arranging flowers shown herein are easy enough to allow the customer to make his or her own arrangements, however, this is not a preferred mode of this invention.

For example, a display might have roses, ferns, babies breath each in a separate container. The customer would come to the stand and buy an arrangement having, for example, roses. The roses would be in one of the embodiments shown herein above, and although the stems might be in water for display, they would be removed from water when the customer bought them. The customer might place the stems in a vase he brought along for the purpose, or he might use a vase purchased at the location for the purpose. Or, in one embodiment ofthis invention, the customer might take the flowers home without water. In this case, preferably, the newly purchased arrangement would be placed in a container 154 for transportation purposes, preferably a box or the like, and the arranged flowers, the arraignment aid and the box are transported home. Once home, the arrangement is removed and placed in a vase of water for display

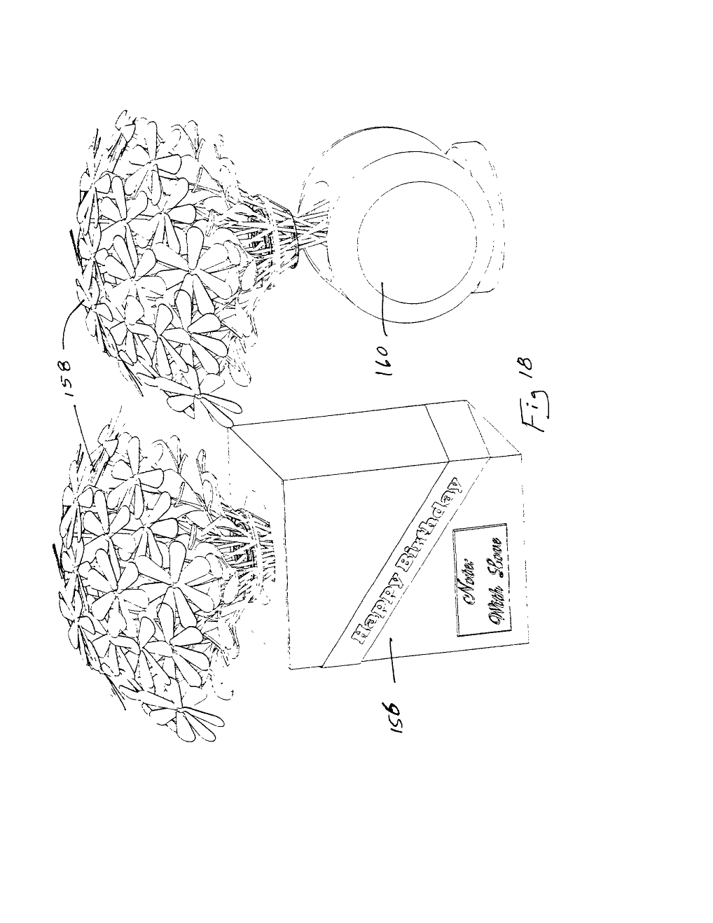

Referring to FIG. 18, in one method of transporting such an arrangement home, the customer can place the arranged flowers 158 in a container 156, preferably, a box with the flower holding device and transport the box, the device and the flowers to the ultimate destination. The flowers and the device are then removed and the arranged flowers and the device are placed in a vase 160 at the destination.

This invention also provides a method for arranging flowers. The particular method is dependent on the nature of the apparatus used and the nature of the arrangement intended by the flower arranger. It must be realized that the bouquet may be held in the flower arranger's hand or placed in a vase or the like as the arrangement is being made.

The central member may or may not define a central aperture, but if one is present, then the first flower is placed therein. In the typical situation, first, a flower is placed in a central orifice of a central member. Then, flower stems are placed in a plurality of flower channels around the central member. Preferably, at least two to eight flower channels will exist around the central member. Herein, it will be assumed that there are three channels around the central member. At this point in the arranging process, there will be three flowers placed around the central member, and one in the center of the central member. The flower stems around the central member are secured by a placing a first surrounding member having a second plurality of flower channels around the first layer of arranged flowers. Similarly to the assumptions made above, herein it will be assumed that there are three flower channels around the first surrounding member, although, as above, there may be between two and eight flower channels around the first surrounding member. If the first outer member comprises a first side member with a second side member, this is the point in the creation of the bouquet that the arranger fits the first and the second side members together. The first surrounding member may be all that is required for the particular arrangement, but, more surrounding members may be added to arrange more flowers. Flower stems are then placed in the second plurality of around the first surrounding member. More layers of flowers can be placed in other surrounding members. Finally, the arranged flowers are placed in a display vase or the like.

As one example, one may have a central member with a central aperture and between about two and ten flower channels, preferably between about two and six. As shown, the first surrounding member has three flower channels and the second surrounding member has five flower channels. This way one dozen flowers may be easily, quickly, and reproducibly arranged, even by a novice or inexperienced florist. Then the arranged flowers may be placed in a vase, for example a ceramic or glass vase. In one embodiment of this invention, the flowers are not placed in a vase, but are held as a bridal bouquet or the like.

Once the arrangement has been made, the flowers in the arrangement will be easier to maintain, since the arrangement can be removed from the display device and new water and new food can be added to the display device, and the flowers can be given fresh cuts to maximize the amount of water and food they can take up. Flowers in such a bouquet will last appreciably longer than in a conventional bouquet.

This invention has been described with reference to specific embodiments and examples thereof. Alterations, modifications, and other changes will invariably suggest themselves to those of ordinary skill in the art. It is intended that the scopes of this invention be determined solely by reference to the appended claims, and that the appended claims encompass all such alterations, modifications, and changes.

We claim:

1. A method of displaying flowers for arrangement at the site of display, and providing a means for transporting the flowers comprising:
placing a supply of pre-made floral arrangements comprising flowers inserted into a flower holder having first member having a first, inner, plurality of flower channels arranged in a radial array, and at least one second member having a plurality of second, outer, flower channels arranged in a radial array, the first member nested inside the second member, the arrangements being placed in arrangement containers;
removing at least one arrangement from at least one of the arrangement containers; and
placing the arrangement inside a flower transportation container.

2. The method of displaying flowers of claim 1 wherein the flower holder includes a first level of channels and a second level of channels, the first level and the second level joined by at least three joining members.

3. The method of displaying flowers of claim 1 where in the flower containers include foliage for floral arrangements.

4. The method of displaying flowers of claim 1 wherein the flower transpiration container is a box having at least one opening in the top surface large enough to allow the floral arrangement to extend outwardly therefrom

5. The method of displaying flowers of claim 1 wherein the method further includes wrapping the floral arrangement with a wrapping selected from the group consisting of cellophane wrap and paper wrap before transporting the arrangement.

6. The method of displaying flowers of claim 1 wherein the method further includes decorating the transportation container used to transport the floral arrangement from the site of display.

7. An aspect of this invention is a method for arranging flowers comprising:
placing at least one first flower stem in at least one flower stem channel of a flower holding member having a plurality of flower s tem channels;
placing at least one second flower stem in a second flower stem channel of the flower holding member having a plurality of flower stem channels, the at least one first flower and the at least one second flower creating an arrangement of flowers; and
placing the arranged flowers in a display device.

8. The method of displaying flowers of claim 7 wherein the flower holder includes a first level of channels and a second level of channels, the first level and the second level joined by at least three joining members.

9. The method of arranging flowers of claim 7 further including the step of placing a flower stem in a central flower stem receiving orifice defined in the center member.

10. The method of arranging flowers of claim 7 further including the step of placing flower stems in between two and ten flower channels defined on the surface of the center member.

11. The method of arranging flowers of claim 7 further including the step of placing flower stems in between two and eight flower channels defined on the surface of each outer member.

12. The method of arranging flowers of claim 11 further including the step of placing a flower stem in a central aperture defined in the center member.

13. The method of arranging flowers of claim 7 further including the steps of fitting a first side member and a second side member together to form an outer member.

14. The method for arranging flowers of claim 7 wherein the method further includes the steps of surrounding a first surrounding member having flower stems placed in a plurality of flower channels with a second surrounding member; and
placing flower stems in a plurality of flower channels.

15. The method of arranging flowers of claim 14 further including the step of binding the stems of the arranged flowers together to form a bundle.

16. A method for transporting flower arrangements comprising:
placing at least one first flower stem in at least one flower stem channel of a flower holding member having a plurality of flower stem channels;
placing at least one second flower stem in a second flower stem channel of the flower holding member having a plurality of flower stem channels;
placing the arranged flowers in a display device; and
transporting the display device with the flowers in the arrangement to a point of display for the flowers.

17. The method of displaying flowers of claim 16 wherein the flower holder includes a first level of channels and a second level of channels, the first level and the second level joined by at least three joining members.

18. The method of transporting flowers of claim 16 further including the step of placing a flower stem in a central flower stem receiving orifice defined in the center member.

19. The method of transporting flowers of claim 16 further including the step of placing flower stems in between two and eight flower channels defined on the surface of the center member.

20. The method of transporting flowers of claim 16 further including the step of placing flower stems in between two and eight flower channels defined on the surface of each outer member.

21. The method of transporting flowers of claim 20 further including the step of placing a flower stem in a central aperture defined in the center member.

22. The method of transporting flowers of claim 16 further including the steps of fitting a first side member and a second side member together to form an outer member.

23. The method for arranging flowers of claim 16 wherein the method further includes the steps of surrounding a first surrounding member having flower stems placed in a plurality of flower channels with a second surrounding member; and
placing flower stems in a plurality of flower channels.

24. The method of transporting flowers of claim 16 further including the step of binding the stems of the arranged flowers together to form a bundle.

25. A method for transporting flower arrangements comprising:
placing at least one first flower stem in at least one flower stem channel of a flower holding member having a plurality of flower stem channels;
placing at least one second flower stem in a second flower stem channel of the flower holding member having a plurality of flower stem channels;
placing the arranged flowers inside the flower holding device in a display device;
at some later sales time, removing the displayed arranged flowers in the flower holding device from the display device and placing them inside a protective transport container; and
transporting the protective transport container containing the flower holding device holding the flower arrangement to a point of display for the flowers.

26. The method of displaying flowers of claim 25 wherein the flower holder includes a first level of channels and a second level of channels, the first level and the second level joined by at least three joining members.

27. The method of transporting flowers of claim 25 further including the step of placing a flower stem in a central flower stem receiving orifice defined in the center member.

28. The method of transporting flowers of claim 25 further including the step of placing flower stems in between two and eight flower channels defined on the surface of the center member.

29. The method of transporting flowers of claim 25 further including the step of placing flower stems in between two and eight flower channels defined on the surface of each outer member.

30. The method of transporting flowers of claim 29 further including the step of placing a flower stem in a central aperture defined in the center member.

31. The method of transporting flowers of claim 25 further including the steps of fitting a first side member and a second side member together to form an outer member.

32. The method for arranging flowers of claim 25 wherein the method further includes the steps of surrounding a first surrounding member having flower stems placed in a plurality of flower channels with a second surrounding member; and
placing flower stems in a plurality of flower channels.

33. The method of transporting flowers of claim 25 further including the step of binding the stems of the arranged flowers together to form a bundle.
